(19) United States
(12) Patent Application Publication
(10) Pub. No.: US 2011/0056876 A1
(43) Pub. Date: Mar. 10, 2011

(54) DESALINATION SYSTEM

(76) Inventors: Takeshi IDE, Tokyo (JP); Takeshi Matsushiro, Yokohama-shi (JP); Yoshiyuki Sakamoto, Toda-shi (JP); Norimitsu Abe, Kawasaki-shi (JP); Futoshi Kurokawa, Tokyo (JP)

(21) Appl. No.: 12/875,647

(22) Filed: Sep. 3, 2010

(30) Foreign Application Priority Data
Sep. 7, 2009 (JP) P2009-206315

(51) Int. Cl. C02F 9/04; C02F 1/461

(52) U.S. Cl. 210/192

(57) ABSTRACT

Certain embodiments provide a desalination system including a desalination plant, a carbon dioxide contacting plant, a carbonate filtering plant, and an electrolysis plant. The desalination plant works to separate raw water into fresh water and high salinity condensed water. The carbon dioxide contacting plant works to bring carbon dioxide into contact with condensed water obtained at the desalination plant, producing carbonates. The carbonate filtering plant works to filter carbonate containing condensed water produced at the carbon dioxide contacting plant, effecting a carbonate removal from condensed water. The electrolysis plant works for an electrolytic treatment of condensed water after the carbonate removal at the carbonate filtering plant to produce a chemical or chemicals for use in the desalination system.

### CROSS-REFERENCE TO RELATED APPLICATION

This application is based upon and claims the benefit of priority from Japanese Patent Application No.2009-206315, filed Sep. 7, 2009; the entire contents of which are incorporated herein by reference.

### HELD

Embodiments described herein relate generally to a desalination system for desalinating saline water.

### BACKGROUND

As methods of desalinating water containing saline matters (salts), such as seawater or brine water, there are three general methods being an evaporation method, an electrodialysis method, and a reverse osmosis method.

Among the three methods, the evaporation method has been employed since longest ago, as a method of heating seawater to evaporate, cooling the water vapor to obtain fresh water. Though being a method allowing for economies of scale to work, the evaporation method does evaporate seawater, consuming large energies, as an issue. Accordingly, the evaporation method is often employed in situation affording to use waste heat such as of a large-scale power generation plant.

The electrodialysis method is a method of running seawater between a cation exchange membrane and an anion exchange membrane, applying a voltage directly from outside the membranes, thereby moving sodium ions being cations and chlorine ions being anions in seawater, to obtain fresh water. The electrodialysis method has increased energy consumption as the salinity increases, and is often employed for desalination of low salinity seawater.

The reverse osmosis method is a method of putting seawater at one side of a semipermeable membrane permeable to water and hardly permeable to saline matters, exerting a prescribed pressure (about 6.5 MPa for instance) on the seawater, to obtain non-saline permeated water (as fresh water) permeated by a reverse osmotic effect. The reverse osmosis method enables desalination with smaller energies than other methods such as the evaporation method or the electrodialysis method, and has been employed recent years for desalination centering on high salinity seawater.

However, in any desalination system employing the evaporation method, the electrodialysis method, or the reverse osmosis method, there is addition of a disinfectant such as chlorine or sodium hypochlorite to seawater (as raw water) to be treated, to prevent troubles in plant, blocking of piping, fouling of membrane (electrodialysis membrane or reverse osmosis membrane), or the like from being caused by biological reproduction in the system. Further, as a pretreatment, there is injection of a flocculant to raw water, to flocculate solid components in raw water, to separate for removal in advance. Before the flocculant injection, there may be addition of a pH controller to control the pH of raw water as necessary for efficient flocculation of solids. In addition, to desalination-treated water also, there may be addition of a PH controller to control the pH, and addition of a disinfectant such as sodium hypochlorite.

Further, in desalination systems employing the electrodialysis method or the reverse osmosis method, metallic components (ions) in seawater may be precipitated on surfaces of a membrane (electrodialysis membrane or reverse osmosis membrane), clogging the membrane. To suppress such the clogging of membrane, there may be use of acids to acidify raw water being treated.

In addition, desalination systems employing the reverse osmosis method are subject to a difficulty to use a reverse osmosis membrane for removal of boron in seawater. To this point, there has been a desalination system (cf. Japanese Patent Application Laying-Open Publication No. 2006-122787) configured with reverse osmosis membranes dual-staged to array tandem, and adapted to add alkali (e.g. sodium hydroxide) to make seawater alkaline before the post-staged reverse osmosis membrane, allowing for an enhanced boron removal rate at the second stage.

As kinds of reverse osmosis membranes available, there are major groups being a cellulose acetate series and a polyamide series. The polyamide series is higher in removal rates such as those of trihalomethane and organic matters than the cellulose acetate series, but larger in degradation due to oxidation by oxidants such as chlorine. Therefore, desalination systems using a polyamide series reverse osmosis membrane need addition of a reductant such as sodium bisulfite (SBS) to remove residual chlorine, for prevention of the degradation due to oxidation (cf. Japanese Patent Application Laying-Open Publication No. 2008-29965).

Such being the case, desalination systems need to supply raw water with chemicals such as a disinfectant, acid, alkali, pH controller, and reductant, thus requiring facilities for supply of chemicals, involving a cumbersome and complicated system configuration, as well as times and labors for chemical transportation and storage, as an issue. Desalination systems adapted to supply raw water with chemicals thus need costs for the chemical supply, as an issue.

To solve such issues concerning chemical supply, there have been also methods including using a diaphragm type electrodialysis cell to electrolyze part of condensed water in a process of desalination treatment, thereby producing chemicals such as an acid, alkali, and disinfectant (chlorine), and making use of produced chlorine in a desalination system (cf. Japanese Patent Application Laying-Open Publication Nos. 6-262172 and 6-269777).

However, condensed water produced in desalination systems contains much multivalent cations such as calcium ions (Ca²⁺) and magnesium ions (Mg²⁺) unrelated to desalination. Multivalent cations such as calcium ions and magnesium ions tend to precipitate on surfaces of an ion exchange membrane in diaphragm electrolyzers, causing a fouling, so multivalent cations contained if any in raw water adversely affect the electrolysis efficiency, increasing power consumption. Further, multivalent cations contained if any in raw water are to be reduced at the negative electrode, with an increase in power consumption. In this regard, there have been desalination systems making use of chemicals produced from condensed water therein, needing increased energies, as a problem.

To reduce consumption rate of chemicals used in desalination, there have been desalination systems disclosed in Japanese Patent Application Laying-Open Publication Nos. 6-262172 and 6-269777, the systems being adapted to implement a method including: (as a first step) injecting alkali (sodium hydroxide) produced in an electrolyzer into condensed water, causing multivalent cations such as calcium ions and magnesium ions to precipitate as hydroxides to be filtered out; (as a second step) reducing multivalent cations to be removed in a diaphragm electrolyzer independent of chemical production; and (as a third step) removing multivalent cations by adsorption to an ion exchange chelate resin, followed by electrolysis of resultant condensed water in a chemical production addressing diaphragm electrolyzer to produce necessary chemicals for use in the desalination systems. This method permits substances produced in a process of desalination treatment to be utilized for fabrication of chemicals to be used in desalination, allowing for reduced amounts of chemicals to be prepared in advance. For removal of Ca²⁺, there may be steps of letting air through an aqueous solution of sodium hydroxide (NaOH), having carbon dioxide adsorbed therein from air to obtain sodium carbonate (Na₂CO₃), and supplying this substituting for alkali in the first step above, to precipitate as calcium carbonate (CaCO₃) to be filtered out.

However, in condensed water, there is e.g. hydroxide (Ca(OH)₂) of calcium ion (Ca²⁺) that has a large solubility of 0.17 g/100 cm³ (at 25° C.) in water. It therefore is still insufficient to simply add alkali (sodium hydroxide) to remove multivalent cations. In this respect, Ca²⁺ is removable to the extent of solubility 0.0014 g/100 cm³ (at 25° C.) of sodium carbonate (Na₂CO₃) having carbon dioxide adsorbed from air, while instead, magnesium carbonate (MgCO₃) has a solubility of 0.0094 g/100 cm³ (at 25° C.), and condensed water has a residual trace of Mg²⁺.

To this point, in Japanese Patent Application Laying-Open Publication Nos. 6-262172 and 6-269777, the desalination systems disclosed have employed the second step requiring an independent diaphragm electrolyzer to be installed, as a problem. Further, in Japanese Patent Application Laying-Open Publication Nos. 6-262172 and 6-269777, the desalination systems disclosed have employed the third step using an ion exchange chelate resin for adsorption of multivalent cations to be removed, involving, among others, an increase in power consumption and a reduction in electrolysis efficiency at a diaphragm electrolyzer for adsorption of multivalent cations, as a problem.

Still more, there has been a technique disclosed in Japanese Patent Application Laying-Open Publication No. 2008-297604, including a direct electrolysis of seawater for producing sodium hypochlorite as a disinfectant.

In Japanese Patent Application Laying-Open Publication No. 2008-297604, the technique disclosed might have been applied to those power generation plants or chemical plants using seawater as coolant water, including electrolysis of seawater to produce sodium hypochlorite, to use as a disinfectant of seawater, allowing for a suppressed biological reproduction such as of shellfish adhering to coolant pipings.

However, in Japanese Patent Application Laying-Open Publication No. 2008-297604, the technique disclosed have employed a direct electrolysis of seawater for producing sodium hypochlorite, involving electrolysis oxidation of bromide ions with formation of carcinogenic bromate ions (BrO₃⁻), such the disinfectant being unfavorable for use to drinkable fresh water.

### BRIEF DESCRIPTION OF THE DRAWINGS

FIG. 1 is a schematic diagram of a desalination system according to an embodiment.

FIG. 2 is an explanatory diagram of a pretreatment plant of the desalination system in FIG. 1.

FIG. 3 is an explanatory diagram of a desalination plant of the desalination system in FIG. 1.

FIG. 4 is an explanatory diagram of an electrolysis pretreatment plant of the desalination system in FIG. 1.

FIG. 5 is an explanatory diagram of an electrolysis plant of the desalination system in FIG. 1.

FIG. 6 is an explanatory diagram of a sodium hypochlorite production plant employable in general desalination systems.

### DETAILED DESCRIPTION

According to certain embodiments there is a desalination system using a chemical or chemicals in a treatment process of producing fresh water from saline raw water. The desalination system includes a desalination plant, a carbon dioxide contacting plant, a carbonate filtering plant, and an electrolysis plant. The desalination plant is configured to separate raw water into fresh water and high salinity condensed water. The carbon dioxide contacting plant is configured to bring carbon dioxide into contact with condensed water obtained at the desalination plant, producing carbonates. The carbonate filtering plant is configured to filter carbonate containing condensed water produced at the carbon dioxide contacting plant, effecting a carbonate removal from condensed water. The electrolysis plant is configured for an electrolytic treatment of condensed water after the carbonate removal at the carbonate filtering plant to produce the chemical or chemicals for use in the desalination system.

There will be described desalination systems according to the embodiments, with reference to the drawings. In the description, like configurations are designated by like reference signs, omitting redundancy.

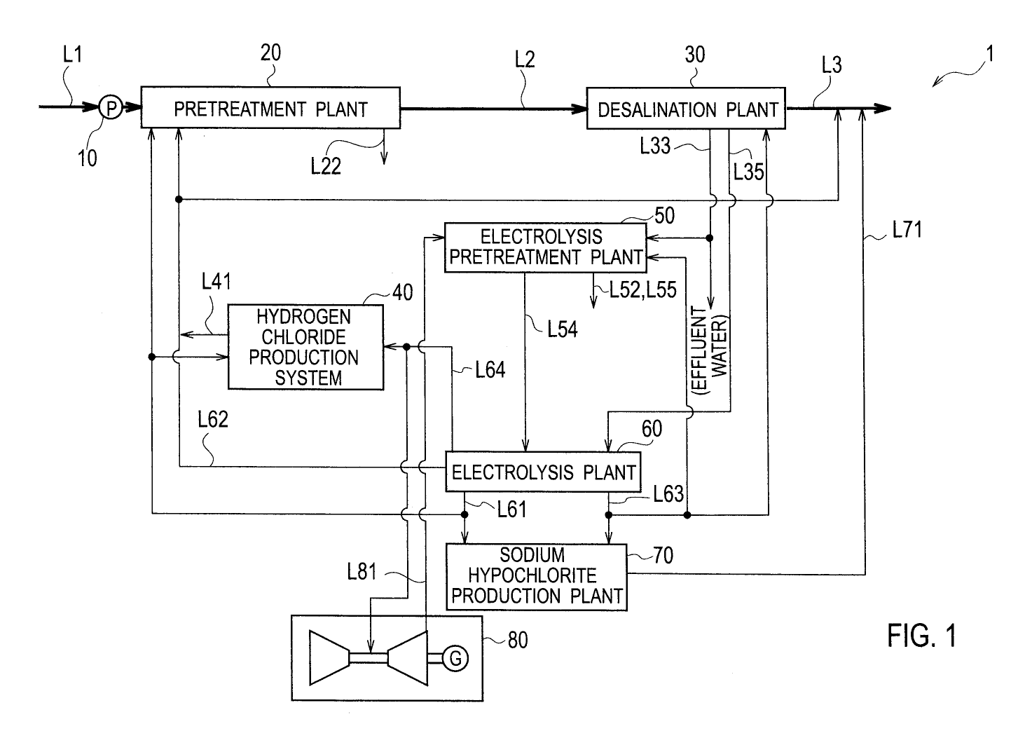

According to an embodiment, as illustrated in FIG. 1, there is a desalination system 1 including a water pump 10, a pretreatment plant 20, and a desalination plant 30. It further includes a hydrogen chloride production plant 40, an electrolysis pretreatment plant 50, an electrolysis plant 60, and a sodium hypochlorite production plant 70. The pump 10 works to send saline raw water such as seawater to the pretreatment plant 20. Raw water is pretreated at the pretreatment plant 20, to introduce to the desalination plant 30, where it is desalinated. The hydrogen chloride production plant 40 works to produce hydrogen chloride for use in treatments at the pretreatment plant 20 and the desalination plant 30. The electrolysis pretreatment plant 50 works for a filtering as a pretreatment of condensed water obtained at the desalination plant 30. The electrolysis plant 60 works for an electrolysis treatment of condensed water pretreated at the electrolysis pretreatment plant 50. The sodium hypochlorite production plant 70 works to produce aqueous sodium hypochlorite for supply to fresh water obtained at the desalination plant 30. Further, the desalination system 1 has a power generation plant 80 connected thereto.

For the desalination system 1, description will be made of an example of desalination of raw water having a salinity level of 3.5% with salt composition containing 78% sodium chloride, 9.8% magnesium chloride, 6.0% magnesium sulfate, 4.0% calcium sulfate, 2.0% potassium chloride, and 0.3% residue.

(Pretreatment Plant)

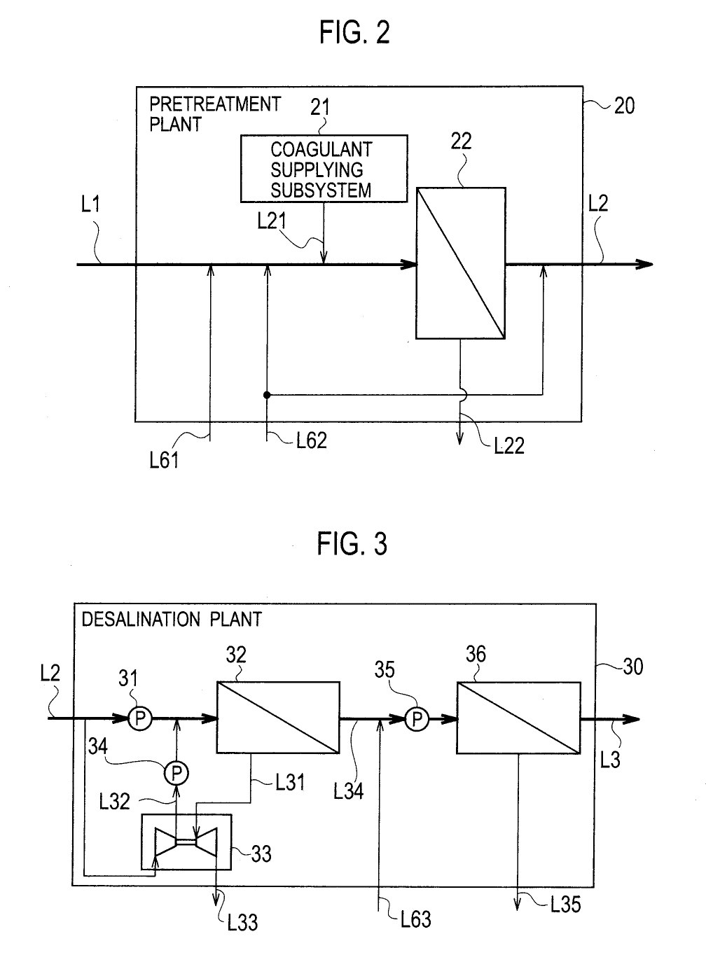

The pretreatment plant 20 is a plant for pretreating raw water to be treated for desalination. As illustrated in FIG. 2, the pretreatment plant 20 has a coagulant supplying subsystem 21 for supplying a coagulant to a first raw water line L1 that conducts raw water sent by the water pump 10, and a filter 22 for filtering raw water supplied with the coagulant.

There is a chlorine line L61 connected with the electrolysis plant 60, for supplying the first raw water line L1 conducting raw water with chlorine gas produced at the electrolysis plant 60. In raw water supplied with chlorine gas, there are shellfish, microorganisms, and the like in seawater killed or disinfected by oxidation effect of chlorine. Disinfecting raw water by chlorine works in subsequent raw water transfer processes to prevent shellfish, microorganisms, and the like in raw water from being reproduced, thereby preventing the desalination system 1 from having reduced treatment efficiencies such as those by trouble or clogging in plant or blocking of line due to reproduction of shellfish, microorganisms, or the like.

The coagulant supplying subsystem 21 has a coagulant supply line L21 configured to supply the first raw water line L1 conducting raw water with a coagulant for coagulating solid substances in raw water. The coagulant supplying subsystem 21 may supply e.g. ferric chloride as a coagulant to raw water. The coagulant supplying subsystem 21 may be set to supply e.g. 2-3 mg/L of coagulant to raw water.

The first raw water line L1 conducting raw water is supplied with a controller from an acidic water line L62 (referred herein to sometimes as a controller line) connected with the electrolysis plant 60. More specifically, there is a controller supplied to control the pH of raw water within a range of 4.0 to 6.5 or near, thereby causing solid substances in raw water to have increased tendencies to be coagulated by the coagulant. There is hydrogen chloride produced at the hydrogen chloride production plant 40, and dissolved in acidic water produced at the electrolysis plant 60 and conducted along the acidic water line L62, to provide the controller being supplied through this line L62.

The filter 22 may be configured as a membrane separator with e.g. multiple stages of MF menbrance modules arrayed in parallel. The filter 22 receives raw water inflowing thereto from the first raw water line L1 and containing solid substances aggregated by the aggregating agent. The filter 22 works to filter inflowing raw water, and send filtrate raw water through a second raw water line L2 to the desalination plant 30.

Filtrate raw water from the filter 22 is controlled to be acidic (about pH 6.5 or less) with a controller supplied through a branch of the controller line L62, to send to the desalination plant 30. Raw water supplied to the desalination plant 30 is thus made acidic, to prevent scale components (metals such as iron and manganese, and carbonates such as those of calcium and magnesium) in raw water from precipitating on surfaces of a membrane in the desalination plant 30 due to condensation or pH variation, causing the membrane to malfunction. Raw water is acidized at the pretreatment plant 20 to send to the desalination plant 30, thereby causing scale components to be dissolved in raw water, affording to prevent scale components from precipitating on membrane surfaces even when raw water is condensed at the desalination plant 30.

The filter 22 is configured to reversely flow backwashing water at prescribed intervals (e.g. 30 minutes), and has an effluent line L22 for discharging effluent water containing solid substances removed from raw water. The filter 22 may be provided as a membrane separator, or any measure else such as a settling pond or filtering pond for filtering solid substances out of raw water.

(Desalination Plant)

The desalination plant 30 is configured as an installation to desalinate saline raw water, including, as illustrated in FIG. 3: a first filter 32 working for a filtering treatment of inflowing raw water from the second raw water line L2; a power-recovery device 33 working to recover pressure energies of condensed water effluent from the first filter 32, for use to exert pressures on raw water; and a second filter 36 working for a filtering treatment of inflowing raw water from the first filter 32.

At the desalination plant 30, inflowing raw water from the second raw water line L2 is sent in part by a pump 31 to the first filter 32, the rest of the inflowing raw water being conducted to the power-recovery device 33. For instance, there may be 60 percent or near (more specifically, about 40 to 70 percent) of the inflowing raw water sent to the first filter 32, the rest of 40 percent or near (more specifically, about 60 to 30 percent) of the inflowing raw water being conducted to the power-recovery device 33. Between raw water sent to the first filter 32 and raw water conducted to the power-recovery device 33, the proportion is controlled in accordance with operating conditions of the first filter 32 and the power-recovery device 33.

The pump 31 is installed on the second raw water line L2. The pump 31 is configured as a high-pressure pump (boost pump) to boost pressures of raw water sent from the pretreatment plant 20, to ensure a required pressure (e.g. 6 to 7 MPa or near (typically, about 6.5 MPa)) retained at the first filter 32, this pressure-controlled raw water being sent to the first filter 32.

The power-recovery device 33 is configured to recover pressure energies of condensed water inflowing through a line L31 from the first filter 32, to give recovered energies to raw water running through the second raw water line L2 into the first filter 32. More specifically, the power-recovery device 33 receives condensed water effluent from the first filter 32, with substantially maintained operating pressures of the first filter 32, and works to recover pressure energies of received condensed water, for use to exert pressures on raw water within a range of about 50 to 100 percent of a pressure required at the first filter 32. For instance, the power-recovery device 33 may employ any system available, such as a piston system or a turbine system using a multi-staged turbine water wheel or the like, for power recovery from pressure energies, so the power-recovery device 33 may be different in performance to exert pressures on raw water by recovery from condensed water.

The power-recovery device 33 has a line L32 for conducting raw water with boosted pressures to make confluent with raw water running in the second raw water line L2. Raw water has pressures increased at the power-recovery device 33, where condensed water has pressures decreased to several hundred kPa or near, the condensed water being effluent through a first condensed water line L33.

The line L32 has a pump 34 installed thereon. The pump 34 may be a high-pressure pump (boost pump) to boost pressures of raw water increased at the power-recovery device 33, to ensure a required pressure retained at the first filter 32, this raw water being confluent with raw water running in the second raw water line L2.

The first filter 32 is configured with a set of reverse osmosis membrane modules using cellulose acetate series membranes (CA membranes), to separate raw water inflowing through the second raw water line L2 into transmembrane water and condensed water, the condensed water being sent with substantially retained operating pressures of the first filter 32 through the line L31 to the power-recovery device 33. The first filter 32 sends raw water (as transmembrane water) deprived of condensed water, through a line L34, to the second filter 36.

There is an alkaline water line L63 connected with the electrolysis plant 60, for supplying alkaline water (aqueous sodium hydroxide) to the line L34 conducting raw water, of which the pH is thereby controlled to 9 or more.

The line L34 has a pump 35 installed thereon. The pump 35 may be a high-pressure pump (boost pump) to boost pressures of raw water in the line L34 supplied with alkaline water for pH control, to send the raw water, ensuring a required water pressure (1 to 3 MPa) retained at the second filter 36.

Also the second filter 36 is configured with a set of reverse osmosis membrane modules using CA membranes, to separate raw water inflowing through the line L34 into transmembrane water and condensed water, the condensed water being effluent through a second condensed water line L35. The second filter 36 sends out raw water (as transmembrane water) deprived of condensed water, as treated water through a treated water line L3.

The raw water being sent to the second filter 36 is controlled to pH 9 or more with supplied alkaline water, so dissolved boron as boric acid in raw water is dissociated as borate ion. Such being the case, the second filter 36 can have an enhanced boron removal performance by changing boric acid in raw water to borate ion. It therefore is possible at the desalination plant 30 to reduce the concentration of residual boron in treated water by supplying alkaline water from the alkaline water line L63.

The first condensed water line L33 is connected to the electrolysis pretreatment plant 50, so condensed water effluent from the power-recovery device 33 is conducted in part to the electrolysis pretreatment plant 50, and utilized at the electrolysis pretreatment plant 50. The electrolysis pretreatment plant 50 can work simply with a necessary amount of condensed water delivered thereto, and the rest of condensed water effluent from the power-recovery device 33 may be released after necessary treatments (e.g. dilution by mixing with seawater) to discharge.

The second condensed water line L35 is connected to the electrolysis plant 60, so condensed water effluent from the second filter 36 is conducted to the electrolysis plant 60 with pressures (1 to 3 MPa) substantially maintained as given by the pump 35, and utilized at the electrolysis plant 60.

As illustrated in FIG. 1, treated water being sent out of the desalination plant 30 runs through the treated water line L3 supplied with a controller through a branch of the controller line L62 connected with the electrolysis plant 60, whereby it is neutralized (about pH 7). The treated water line L3 conducting treated water is supplied with an aqueous solution of sodium hypochlorite from a sodium hypochlorite line L71 connected with the sodium hypochlorite production plant 70, whereby the treated water undergoes a disinfectant treatment, to be sent to users.

(Modification of Desalination Plant)

In the example described, the first filter 32 as well as the second filter 36 has employed membrane modules using a CA membrane. Instead, there may be combination of a first filter 32 using a CA membrane and a second filter 36 using a polyamide series membrane (PA membrane). PA membranes have a low tolerance to chlorine and tendencies to degrade with chlorine, and are non-adaptive for filtration of saline raw water, while the second filter 36 can be free of membrane degradation due to chlorine, if the first filter 32 using CA membrane is adapted for sufficient removal of chlorine. On the other hand, PA membranes can remove boron and organic substances that CA membranes are unable to remove sufficiently.

Accordingly, employing combination of the first filter 32 using CA membrane and the second filter 36 using PA membrane permits both CA and PA membranes to be used, affording for the first filter 32 using CA membrane to remove chlorine, and for the second filter 36 using PA membrane to remove trihalomethane and organic substances that the first filter 32 using CA membrane has failed to remove.

There may be combination of a first filter 32 employing membrane modules using a PA membrane and a second filter 36 employing membrane modules using a PA membrane. Also, employing combination of the first filter 32 using PA membrane and the second filter 36 using CA membrane permits both CA and PA membranes to be used, affording to expect produced effects of both membranes. In this case, the first filter 32 using PA membrane is to work for a filtering treatment before the second filter 36 using CA membrane works to remove chlorine, with the need of adding a reductant such as sodium bisulfite (SBS) to raw water being sent to the desalination plant 30, for removing residual chlorine in raw water to prevent degradation of PA membrane due to chlorine.

(Hydrogen Chloride Production Plant)

The hydrogen chloride production plant 40 is configured as an installation for making use of chlorine and hydrogen to produce hydrogen chloride. More specifically, the hydrogen chloride production plant 40 receives chlorine supplied from the electrolysis plant 60 through the chlorine line L61, and hydrogen supplied from the electrolysis plant 60 through a hydrogen line L64, making use of them to produce hydrogen chloride. The hydrogen chloride production plant 40 supplies produced hydrogen chloride through a hydrogen chloride line L41 to the acidic water line L62 conducting acidic water. With hydrogen chloride mixed, acidic water works as a controller. The controller, thus produced at the hydrogen chloride production plant 40, is supplied to the pretreatment plant 20, and added to treated water running through the treated water line L3.

Hydrogen chlorine produced at this plant 40 may be dissolved in water to produce hydrochloric acid, for use of hydrochloric acid as a controller to control the pH in the desalination treatment.

(Electrolysis Pretreatment Plant)

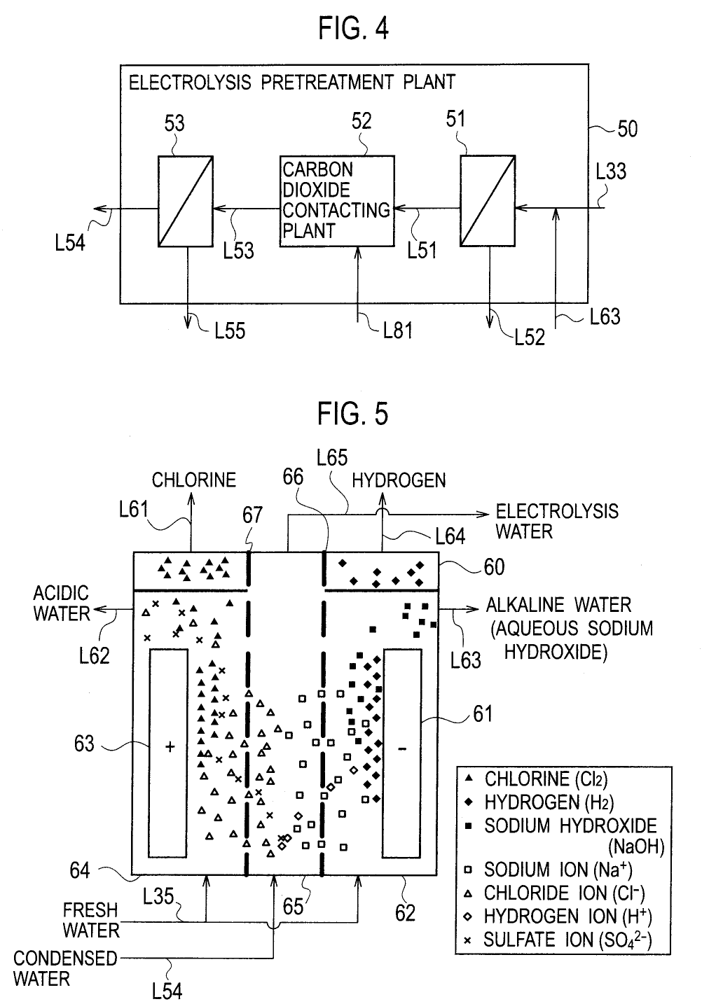

The electrolysis pretreatment plant 50 is configured as an installation to remove, from condensed water, impurities therein such as multivalent cations including calcium ion (Ca²⁺) and magnesium ion (Mg²⁺). As illustrated in FIG. 4, the electrolysis pretreatment plant 50 includes: a hydroxide filtering plant 51 configured to filter condensed water inflowing through the first condensed water line L33; a carbon dioxide contacting plant 52 configured to bring carbon dioxide gas into contact with filtrate water filtrated at the hydroxide filtering plant 51; and a carbonate filtering plant 53 configured to filter carbonate-containing treated water produced at the carbon dioxide contacting plant 52.

The electrolysis pretreatment plant 50 receives condensed water inflowing through the first condensed water line L33 connected with the desalination plant 30. Condensed water inflowing through the first condensed water line L33 contains salts removed from raw water at the desalination plant 30, and impurities such as multivalent cations including calcium ion (Ca²⁺) and magnesium ion (Mg²⁺). Therefore, in the electrolysis pretreatment plant 50, inflowing condensed water is supplied with alkaline water (aqueous sodium hydroxide) produced at the electrolysis plant 60 and conducted therefrom through the alkaline water line L63, so condensed water is controlled to pH 9 or more. In condensed water supplied with alkaline water, there are produced insoluble hydroxides of multivalent cations such as calcium ion (Ca²⁺) and magnesium ion (Mg²⁺).

The hydroxide filtering plant 51 receives inflowing condensed water as supplied with alkaline water. The hydroxide filtering plant 51 works to filter out, from condensed water, insoluble hydroxides of multivalent cations such as calcium ion and magnesium ion, and send condensed water (as filtrate water) deprived of such hydroxides, through a line L51, to the carbon dioxide contacting plant 52. Here, hydroxides have their solubilities in water, such that calcium hydroxide, 0.17 g/100 cm³ (at 25° C.), and magnesium hydroxide, 0.0012 g/100 cm³ (at 25° C.), so calcium hydroxide is membrane-permeable as part of membrane-filtrated water.

The hydroxide filtering plant 51 is configured to reverse wash hydroxides removed from condensed water by filtration, to discharge through an effluent line L52. Here, the hydroxide filtering plant 51 may employ, as reverse washing water, an acidic solution obtained by dissolving hydrogen chloride produced at the hydrogen chloride production plant 40 in acidic water produced at the electrolysis plant 60, affording to dissolve, to discharge, dirt matters such as hydroxides adhering to surfaces of membrane in the hydroxide filtering plant 51.

The carbon dioxide contacting plant 52 receives condensed water inflowing from the hydroxide filtering plant 51, and effluent gases rich in carbon dioxide supplied from a carbon dioxide gas line L81 connected with the power generation plant 80. The carbon dioxide contacting plant 52 is adapted to bring carbon dioxide gas into contact with condensed water, thereby producing carbonates between carbon dioxide and multivalent cations such as calcium ion and magnesium ion, and send condensed water (as treated water) containing carbonates through a line L53 to the carbonate filtering plant 53. For instance, it works to change calcium ions having permeated membranes in the hydroxide filtering plant 51 in the form of calcium hydroxide, into water-insoluble calcium carbonate particulate. The carbon dioxide contacting plant 52 may work to discharge any amounts of carbon dioxide left unreacted with multivalent cations, as effluent gases.

The electrolysis pretreatment plant 50 may include a bubble generator (non-depicted) for generating microscopic bubbles of carbon dioxide gas, such as microbubbles of several micrometers or smaller or nanobubbles of several nanometers or smaller. Bringing microscopic bubbles of carbon dioxide gas affords for an enhanced efficiency in contact with multivalent cations, allowing for an enhanced efficiency in carbonate production, as well.

The carbonate filtering plant 53 works to filter condensed water (treated water) inflowing from the carbon dioxide contacting plant 52. It effects a removal of such carbonates from condensed water that have been produced with multivalent cations such as calcium ion and magnesium ion and unremoved at the hydroxide filtering plant 51. The carbonate filtering plant 53 further works to send condensed water (as treated water) deprived of carbonates, through a condensed water line L54, to the electrolysis plant 60. Here is thus implemented contact between condensed water and carbon dioxide gas at the carbon dioxide contacting plant 52, affording to effect a sufficient removal of calcium ions and magnesium ions in condensed water (as treated water). In this respect, for instance, calcium carbonate has a solubility of 0.0014 g/100 cm³ (at 25° C.) in water.

The carbonate filtering plant 53 is adapted to reverse wash carbonates removed from condensed water, to discharge through an effluent line L55. Here, the carbonate filtering plant 53 may employ, as reverse washing water, an acidic solution obtained by dissolving hydrogen chloride produced at the hydrogen chloride production plant 40 in acidic water produced at the electrolysis plant 60, affording to dissolve, to discharge, dirt matters such as hydroxides adhering to surfaces of membrane in the carbonate filtering plant 53.

Assuming the power generation plant 80 to be an electric power station or such located near the desalination system 1, FIG. 1 and FIG. 4 shows the carbon dioxide contacting plant 52 making use of carbon dioxide contained in effluent gases effluent from the power generation plant 80, achieving effective utilisation of carbon dioxide produced at the power generation plant 80, allowing for a reduced emission of carbon dioxide gas to the atmosphere. It is noted that the carbon dioxide contacting plant 52 may employ carbon dioxide collected from the air, while the concentration of carbon dioxide in the air is lower than those in effluent gases of power generation plants, so carbon dioxide in effluent gases of power generation plant 80 had better be employed with the more efficient production of carbonates.

(Electrolysis Plant)

The electrolysis plant 60 is configured as a diaphragm electrolyzer including, as illustrated in FIG. 5: a negative electrode 61 installed in a negative electrode chamber 62; a positive electrode 63 installed in a positive electrode chamber 64; an electrolytic treatment chamber 65 interposed between the negative electrode chamber 62 and the positive electrode chamber 64; a cation exchange membrane 66 installed for separation between the negative electrode chamber 62 and the electrolytic treatment chamber 65; and an anion exchange membrane 67 installed for separation between the positive electrode chamber 64 and the electrolytic treatment chamber 65.

The electrolytic treatment chamber 65 receives condensed water inflowing through the condensed water line L54 connected with the electrolysis pretreatment plant 50, the condensed water having been well deprived of multivalent cations such as calcium ion and magnesium ion (with sodium chloride concentrations: about 5% to 10%). With a voltage applied between the negative electrode 61 and the positive electrode 63, as illustrated in FIG. 5, there are cations such as sodium ions (Na⁺) in condensed water activated to move, penetrating the cation exchange membrane 66, from the electrolytic treatment chamber 65 to the negative electrode chamber 62.

The negative electrode chamber 62 receives such substantially fresh water 46 that is effluent as condensed water at the second filter 36 in the desalination plant 30 and supplied therefrom through the second condensed water line L35. As sodium ions enter from the electrolytic treatment chamber 65, the negative electrode chamber 62 has an increased sodium ion concentration, producing alkaline water (aqueous sodium hydroxide) of 0.1 to 3 N. Concurrently, hydrogen is produced at the negative electrode 61. As illustrated in FIG. 1, alkaline water produced in the negative electrode chamber 62 is supplied for use, through the alkaline water line L63, to the desalination plant 30, the electrolysis pretreatment plant 50, and the sodium hypochlorite production plant 70. Alkaline water may be used also for producing sodium bisulfite (SBS) for use to prevent degradation of reverse osmosis membrane module due to oxidation by chlorine, or for controlling pH in other processes. Further, as illustrated in FIG. 1, hydrogen produced in the negative electrode chamber 62 is supplied through the hydrogen line L64 to the hydrogen chloride production plant 40 and the power generation plant 80.

At the electrolysis plant 60, condensed water inflowing from the condensed water line L54 to the electrolytic treatment chamber 65 contains, besides sodium ion (Na+), such anions as carbonate ion (CO₃⁻) and chloride ion (Cl⁻). With a voltage applied between the negative electrode 61 and the positive electrode 63, as illustrated in FIG. 5, there are anions such as carbonate ions and chloride ions in condensed water activated to move, penetrating the anion exchange membrane 67, from the electrolytic treatment chamber 65 to the positive electrode chamber 64.

At the positive electrode chamber 64 which is supplied with fresh water 46, carbonate ions and chloride ions in condensed water of the electrolytic treatment chamber 65 enter, increasing their concentrations, thus producing acidic water. Concurrently, chloride ions (Cl⁻) are oxidized at the positive electrode 63, producing chlorine (Cl₂). As illustrated in FIG. 1, acidic water produced in the positive electrode chamber 64 is conducted through the acidic water line L62, where it is controlled within a range of pH1 to pH6 by dissolving hydrogen chloride produced at the hydrogen chloride production plant 40, to supply as a controller to the pretreatment plant 20, and mix to treated water as desalinated at the desalination plant 30. Chlorine produced at the positive electrode chamber 64 is supplied through the chlorine line L61 to the pretreatment plant 20, the hydrogen chloride production plant 40, and the sodium hypochlorite production plant 70. Chlorine may be otherwise employed as a disinfectant for fresh water.

Electrolysis water with decreased salt concentration (cation, anion) is effluent from the electrolytic treatment chamber 65, through an electrolysis water line L65, for use to dilute unelectrolyzed condensed water for instance, before releasing to the sea. Salinity-decreased electrolysis water may be returned to raw water.

(Sodium Hypochlorite Production Plant)

The sodium hypochlorite production plant 70 is an installation supplied with alkaline water (aqueous sodium hydroxide) and chlorine produced at the electrolysis plant 60, and adapted for contacting them each other to produce aqueous sodium hypochlorite.

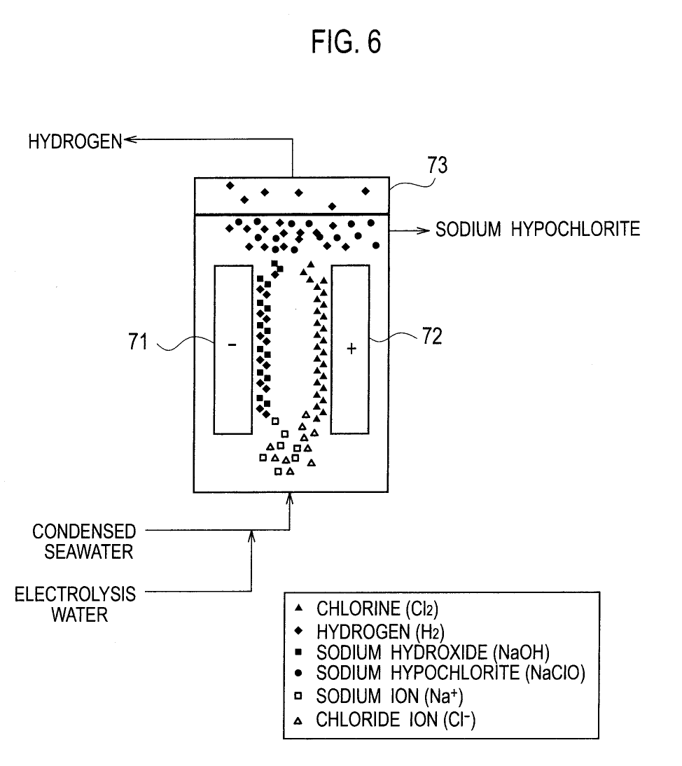

FIG. 6 illustrates a typical sodium hypochlorite production plant configured with a reaction cell 73 having a negative electrode 71 and a positive electrode 72 installed therein, and adapted to electrolyze seawater or condensed seawater, to implement an electrolytic process for producing aqueous sodium hypochlorite. This embodiment also might well employ such a sodium hypochlorite production plant as illustrated in FIG. 6, that however might work on treated water containing a high concentration of bromide ions (Br⁻), electrolyzing bromide ions, thus forming carcinogenic bromate ions (BrO₃⁻) as by-product, besides production of sodium hypochlorite. Therefore, in systems sending fresh water as drinkable water to users, employing such a sodium hypochlorite production plant as illustrated in FIG. 6, making use of aqueous sodium hypochlorite thereof as a disinfectant would have needed provision of countermeasures against bromate ion (BrO₃⁻), such as a removal of bromide ion (Br⁻) before the electrolysis.

To this point, according to the embodiment, aqueous sodium hydroxide and chlorine produced at the electrolysis plant 60 are brought into contact with each other to produce aqueous sodium hypochlorite, so the sodium hypochlorite production plant is substantially kept free of invading bromide ions, successfully suppressing formation of bromate ion.

(Power Generation Plant)

The power generation plant 80, which may be an electric power generator such as a gas turbine generator for instance, is configured to receive a fuel gas such as a natural gas supplied thereto, and hydrogen produced at the electrolysis plant 60 and supplied therefrom through the hydrogen line L64, as illustrated in FIG. 1. The power generation plant 80 is supplied with air in the atmosphere, and adapted for combustion of fuel gas and hydrogen to generate electricity.

The power generation plant 80 has combustion product gases effluent as flue gases containing much carbon dioxide (CO₂), which are supplied through the carbon dioxide gas line L81 to the electrolysis pretreatment plant 50.

According to embodiments described, there is a desalination system 1 including an electrolysis pretreatment plant 50 provided with a hydroxide filtering plant 51 that is configured to remove insoluble hydroxides of multivalent cations from condensed water pH-controlled with alkaline water, before entering electrolysis of condensed water at an electrolysis plant 60. The electrolysis pretreatment plant 50 further has a carbon dioxide contacting plant 52 configured to bring carbon dioxide gas into contact with condensed water, producing carbonates of multivalent cations, and a carbonate filtering plant 53 configured to remove such carbonates from condensed water, before the electrolysis of condensed water at the electrolysis plant 60. Accordingly, in the desalination system 1, condensed water to be treated at the electrolysis plant 60 is sufficiently deprived of multivalent cations (for sodium chloride 5% to 10%), affording to suppress degradation of electrolysis efficiency due to a fouling by precipitation on surfaces of ion exchange membrane, and consumption of power due to multivalent cations being reduced on a negative electrode in the electrolysis plant 60, together with resultant electrode deterioration and cost increase. There are substances produced in processes for desalination treatment of water and utilized for preparation of chemicals as necessary for removal of multivalent cations, allowing for reduced costs for chemicals to be prepared.

The desalination system 1 is adapted at the electrolysis pretreatment plant 50 for adding alkaline water (aqueous sodium hydroxide) to condensed water to produce insoluble hydroxides of multivalent cations such as calcium ion and magnesium ion, to remove by filtration, before bringing carbon dioxide gas into contact with condensed water to produce carbonates of multivalent cations such as calcium ion and magnesium ion, to remove by filtration. Condensed water that has been acidic since treatment at a desalination plant 30 is once tuned alkaline, to contact with carbon dioxide gas, providing greater tendencies to precipitate calcium carbonate than would be by contact in acidic state. This affords to suppress invasion of calcium ions that otherwise might have made a fouling on membrane causing degradation of electrolysis efficiency at the electrolysis plant 60, thus allowing for an extended service life of the electrolysis plant 60 with a reduced electrolysis cost. If carbon dioxide gas were brought into contact with condensed water to change ions in condensed water to carbonates, before raising the pH to 9 or more by use of alkaline water (aqueous sodium hydroxide), then the carbonate concentration would have been increased. Namely, for filtrate water being more acidic than condensed water, the pH would have been raised to 9 or more with increased consumption rate of alkali (sodium hydroxide). Therefore, rendering condensed water alkaline to contact with carbon dioxide gas permits the amount of alkaline water (aqueous sodium hydroxide) required to be the more reduced, allowing for a reduced cost as necessary for the electrolysis.

The desalination system 1 is adapted to bring chlorine produced at the electrolysis plant 60 into contact with alkaline water (aqueous sodium hydroxide) produced at the electrolysis plant 60, so invasion of bromide ion is substantially kept from occurring at a sodium hypochlorite production plant 70, allowing for a suppressed formation of bromate ion.

The desalination system 1 includes a power generation plant 80 discharging flue gases with high concentration of carbon oxide gas, which are brought into contact with filtrate water, permitting an efficient carbonate production. There may be use of carbon dioxide gas rendered as microbubbles or nanobubbles to contact with filtrate water, with an increased efficiency of contact between filtrate water and carbon oxide gas, affording to increase the production rate of carbonates, allowing for the carbon dioxide contacting plant 52 to be down-scaled.

In addition, carbon oxide in flue gases of the power generation plant 80 may be changed to calcium hydroxide, to separate as insoluble solids. This permits carbon oxide to be fixed, affording to reduce the emission of carbon dioxide of power plant on which imposed rules are getting stricter year by year with the problems of global warming. Further, there may be a plenty of hydrogen produced by electrolysis and utilized in part as a fuel for power generation, affording for effective use of hydrogen produced in the desalination plant 1, with an increased efficiency in use of energy.

While certain embodiments have been described, these embodiments have been presented by way of example only, and are not intended to limit the scope of inventions. Indeed, the novel methods and systems described herein may be embodied in a variety of other forms: furthermore, various omissions substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A desalination system using a chemical or chemicals in a treatment process of producing fresh water from saline raw water, the desalination system comprising:
a desalination plant configured to separate raw water into fresh water and high salinity condensed water;
a carbon dioxide contacting plant configured to bring carbon dioxide into contact with condensed water obtained at the desalination plant, producing carbonates;
a carbonate filtering plant configured to filter carbonate containing condensed water produced at the carbon dioxide contacting plant, effecting a carbonate removal from condensed water; and
an electrolysis plant configured for an electrolytic treatment of condensed water after the carbonate removal at the carbonate filtering plant to produce said chemical or chemicals for use in the desalination system.

2. The desalination system according to claim 1, further comprising:
an alkaline water line configured to supply alkali to condensed water to be sent to the carbon dioxide contacting plant; and
a hydroxide filtering plant configured to constitute a pre-stage of the carbon dioxide contacting plant, to filter condensed water containing hydroxides produced with alkali supplied through the alkaline water line, effecting a hydroxide removal, to send condensed water to the carbon dioxide contacting plant.

3. The desalination system according to claim 2, wherein the electrolysis plant is configured to produce alkali as a chemical from condensed water, and the alkaline water line is configured to supply alkali produced at the electrolysis plant to condensed water.

4. The desalination system according to claim 1, comprising:
the electrolysis plant being configured to produce alkali and chlorine as chemicals from condensed water; and
a sodium hypochlorite production plant configured for reactions of alkali and chlorine produced at the electrolysis plant to produce sodium hypochlorite as a chemical.

5. The desalination system according to claim 4, further comprising a sodium hypochlorite line configured to supply sodium hypochlorite produced at the sodium hypochlorite production plant to fresh water obtained at the desalination plant.

6. The desalination system according to claim 1, wherein the electrolysis plant is configured to produce from condensed water as chemicals chlorine and hydrogen and acidic water, and provided with a hydrogen chloride production plant configured for reactions of chlorine and hydrogen produced at the electrolysis plant to produce hydrogen chloride gas, and a facility configured to dissolve hydrogen chloride gas produced at the hydrogen chloride production plant in acidic water produced at the electrolysis plant, producing hydrochloric acid as another chemical.

7. The desalination system according to claim 1, comprising:
a microscopic bubble generator configured to generate microscopic bubbles of hydrogen chloride gas; and
the carbon dioxide contacting plant being configured to bring microscopic bubbles of hydrogen chloride gas generated at the microscopic bubble generator into contact with condensed water.

8. The desalination system according to claim 1, comprising:
a connected power generation plant; and
the carbon dioxide contacting plant being configured to use hydrogen chloride gas in effluent gases effluent from the power generation plant as hydrogen chloride gas to be brought into contact with condensed water.

9. The desalination system according to claim 8, wherein the electrolysis plant is configured to supply the power generation plant with hydrogen produced at the electrolysis plant.
